(19) United States
(12) Patent Application Publication
(10) Pub. No.: US 2006/0203488 A1
(43) Pub. Date: Sep. 14, 2006

(54) LED device for illuminating objects

(75) Inventor: Perviaz Lodhie, Rolling Hills, CA (US)

Correspondence Address: IRVING KESCHNER, 21535 HAWTHORNE BOULEVARD, SUITE 385, TORRANCE, CA, 90503, US

(73) Assignee: Ledtronics, Inc.

(21) Appl. No.: 11/078,079

(22) Filed: Mar. 10, 2005

(51) Int. Cl. F21V 21/00

(52) U.S. Cl. 362/249

(57) ABSTRACT

A source of illumination comprising an array of light emitting diodes (LEDs) mounted to a printed circuit board (PCB) which in turn is secured to the inner wall of a cylindrically shaped frame member. The frame member has a cuttout portion through which the illumination generated by the LEDs, when energized, is emitted and illuminates an adjacent object, such as a piece of art. The frame member has an end portion which enables it to partially swivel about its horizontal axis when mounted in a socket. In a preferred embodiment, 64 LEDs are utilized, the LEDs being energized by the rectified output from a conventional AC power source.

### BACKGROUND OF THE INVENTION

1. Field of the Invention

The present invention provides a cylindrically shaped device having a plurality of LEDs mounted therein, the light generated thereby being directed to an art object located adjacent thereto.

2. Description of the Prior Art

Devices for illuminating art objects, such as paintings, have long been available in the prior art. Typically, the illuminating device comprises a single incandescent bulb mounted within a housing, the illumination emitted by the bulb being directed over the surface of the painting or other works of art.

While the technology underlying the use of incandescent lights is familiar, there are a number of shortcomings that make their use less than ideal. For example, the incandescent light sources adapted for this use typically have a short life expectancy after which time they must be replaced, thereby, incurring maintenance costs related to labor, replacement parts, and inventory overhead and storage. In addition, incandescent lights consume a relatively large amount of power and generate heat and UV light, UV Light being harmful to paintings.

Furthermore, incandescent light sources typically employ a single lighting filament or alternatively multiple lighting filaments electrically connected in series. Consequently, the failure of any one filament results in the complete failure of the light source. Such an all-out failure results in increased costs for replacement bulbs.

In typical museum settings, these added costs can seriously impact budget considerations.

What is thus desired is to provide a source for illuminating art objects, such as paintings, for viewing wherein the light source has a relatively long life, has low power requirements and wherein heat generation is minimized.

### SUMMARY OF THE INVENTION

The present invention provides a source of illumination comprising an array of light emitting diodes (LEDs) mounted to a printed circuit board (PCB) which in turn is secured to the inner wall of a cylindrically shaped frame member in a preferred embodiment. The frame member has a cutout portion through which the illumination generated by the LEDs, when energized, is emitted and illuminates an adjacent object, such as a piece of art. The frame member has an end portion which enables it to partially swivel about its horizontal axis when mounted in a socket. In a preferred embodiment, 64 LEDs are utilized, the LEDs being energized by the rectified output from a conventional AC power source or directly from a DC power source.

The present invention thus provides an improved source for illuminating objects and in particular, art objects, enabling the object to be easily viewed, the source having a relatively long life and reduced power requirements which, in turn, generates minimal heat. This latter feature provides the additional benefit of preserving the object from possible damage caused by excessive heat generated by conventional illumination devices.

### DESCRIPTION OF THE DRAWINGS

For a better understanding of the present invention as well as other objects and further features thereof, reference is made to the following description which is to be read in conjunction with the accompanying drawing wherein:

FIG. 1 illustrates the LED device of the present invention illuminating a picture;

FIG. 2 is a front view of the LED light of the present invention;

FIG. 3 is a front view of the LED light of the present invention;

FIG. 4 is a cross-sectional view along line 4-4 of FIG. 3;

FIG. 5 is a cross-sectional view along line 5-5 of FIG. 2;

FIG. 6 is a view similar to FIG. 5 illustrating that the LED light frame has been rotated;

FIG. 7 is an exploded view of the light frame and light socket with the light frame broken array;

FIG. 8 is a cross-sectional view along line 8-8 of FIG. 2;

FIG. 9 is a side view of another embodiment of the present invention illustrating the socket modified to fit into a standard light socket; and

FIGS. 10-12 illustrate a third embodiment of the present invention.

### DESCRIPTION OF THE INVENTION

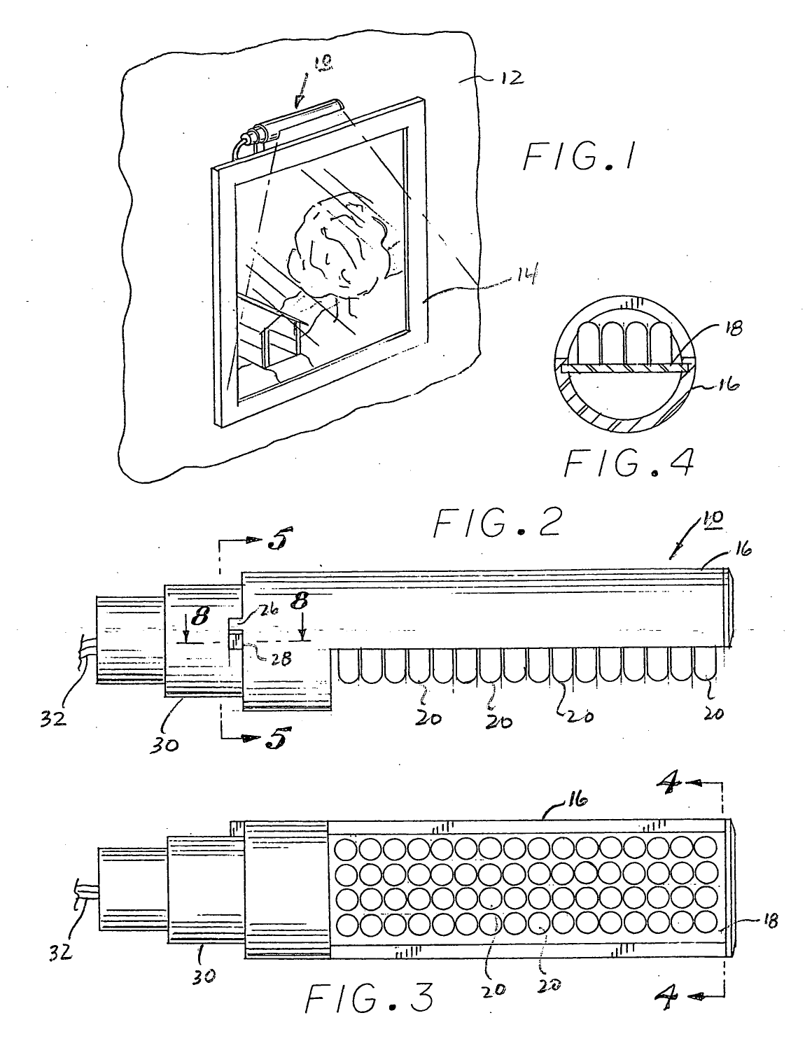

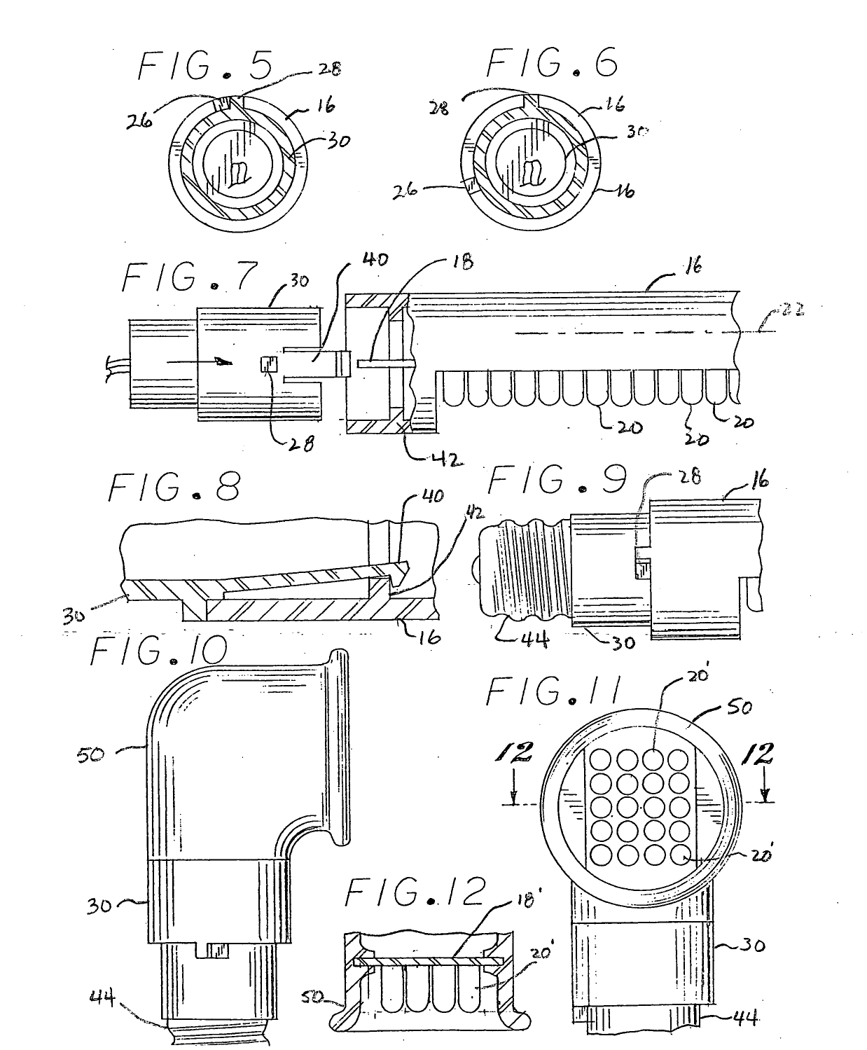

Referring now to FIGS. 1-8, a first and preferred embodiment of the present invention is illustrated.

FIG. 1 shows the LED device 10 of the present invention mounted to wall 12 and above picture 14.

Device 10 comprises a frame member 16 having a printed circuit board (PCB) 18 positioned within slots formed in the frame member 16. A plurality of light emitting diodes (LEDs) 20 are mounted to PCB 18 in a conventional manner. In a preferred embodiment, sixty four LEDs as illustrated are utilized although more or less LEDs could be utilized. Lug 26 on frame member 16 and lug 28 on socket 30 are provided to limit the rotation of frame member 16 about axis 22 with respect to fixed socket 30 to one complete turn and then back again to protect the electrical connection 32 and to enable the direction of the light emitted by the LEDs to be adjusted. Although not illustrated, an AC power source is connected to socket 30 via connection 32, the AC power being rectified by a circuit on PCB 18 to provide the necessary dc voltage to energize the LEDs 20. Alternately, a DC power source can be utilized to power the LEDs, the source in this case preferably being 12 volts DC. PCB 18 slides into two channels formed in the interior surface of frame member 16 as shown in FIG. 4, the PCB 18 thereby being supported within frame member 16.

FIGS. 7 and 8 illustrate the locking tab 40 formed on socket 30; the locking tab 40 engaging rib 42 when socket 30 is inserted into frame member 16 thus removably securing the two components together.

The electrical connections from the rectified AC power source to the LEDs 20 have not been illustrated since it utilizes conventional techniques.

The rectified power energizes the LEDs, the light emitted thereby illuminating the adjacent object.

FIG. 9 illustrates a modified version of the embodiment shown in FIGS. 1-8 wherein the base of socket 30 is modified to incorporate a threaded portion 44 enabling LED device 10 to be screwed directly into a standard light socket.

FIGS. 10-12 show a third embodiment of the present invention wherein frame member 16 is formed into a right angle shape frame member 50. The modified threaded base 44 is also utilized. LEDs 20′ project light essentially, perpendicular to the longitudinal axis of socket 30 onto an object positioned adjacent thereto. PCB 18′ slides into frame 50 and is supported thereby.

The present invention thus provides a LED device specifically adapted to illuminate a work of art, such as a painting, and as a result, eliminate the deleterious effects of illumination generated by incandescent bulbs that are typically used to illuminate such works of art.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A LED device for illuminating an object comprising:
a cylindrically shaped frame member, the frame member having a cutout portion;
a printed circuit board having a plurality of LEDs mounted thereto, said printed circuit board being positioned within said frame member in a manner such that the illumination from said LEDs is emitted from said cutout portion;
a socket member removably secured to said frame member; and
means for energizing said LEDs whereby said LEDs generate said illumination.

2. The LED device of claim 1 wherein said frame member is rotatably positioned with respect to said socket member.

3. The LED device of claim 2 wherein said LED device is mounted to a wall and the object is positioned adjacent thereto.

4. The LED device of claim 2 wherein said LEDs are arranged in a plurality of rows on said printed circuit board.

5. The LED device of claim 4 wherein means are provided to limit the rotation of said frame member with respect to said socket.

6. The LED device of claim 5 wherein the printed circuit board slides into channels formed in the interior surface of said frame member.
